(19) United States
(12) Patent Application Publication
(10) Pub. No.: US 2006/0246284 A1
(43) Pub. Date: Nov. 2, 2006

(54) Fabric reinforcement using modified cyclic olefin copolymer and resin substrate for printed circuit board

(75) Inventors: Jun Rok Oh, Seoul (KR); Cheol Ho Choi, Gyeonggi-do (KR); Tae Kyoung Kim, Gyeonggi-do (KR)

Correspondence Address: DARBY & DARBY P.C., P. O. BOX 5257, NEW YORK, NY, 10150-5257, US

(73) Assignee: Samsung Electro-Mechanics Co., Ltd., Gyeonggi-do (KR)

(21) Appl. No.: 11/355,522

(22) Filed: Feb. 15, 2006

(30) Foreign Application Priority Data
Apr. 29, 2005 (KR) 10-2005-0035934

(51) Int. Cl. D02G 3/00; F16J 15/20

(52) U.S. Cl. 428/364; 428/365; 428/374

(57) ABSTRACT

The present invention is related to a fabric reinforcement using a modified cyclic olefin copolymer and a resin substrate for a printed circuit board. Specifically, the current invention provides a fabric reinforcement using a modified cyclic olefin copolymer, which is prepared from filaments obtained by melting the modified cyclic olefin copolymer including a cyclic olefin copolymer backbone grafted with a monomer having at least one unsaturated carboxylic group, and a resin substrate for a printed circuit board.

### INCORPORATION BY REFERENCE

The present application claims priority under 35 U.S.C. §119 to Korean Patent Application No. 10-2005-0035934 filed on Apr. 29, 2005. The content of the application is incorporated herein by reference in its entirety.

### BACKGROUND OF THE INVENTION

1. Field of the Invention

The present invention relates, generally, to a fabric reinforcement using a modified cyclic olefin copolymer and a resin substrate for a printed circuit board (PCB). More particularly, the present invention relates to a fabric reinforcement, which is incorporated into a polymer resin to improve mechanical properties, in particular, increase stiffness, of a copper clad laminate (CCL) and a prepreg as a material for a PCB, and thus, by virtue of the use of a modified cyclic olefin copolymer, has a lower dielectric constant and a lower dissipation factor than those of a conventional glass fabric material, thereby manifesting excellent high-frequency properties, and to a resin substrate for a PCB.

2. Description of the Related Art

With the recent advent of a highly information-intensive society, communication systems such as mobile phones, satellite telecommunications, wireless networks, etc., are digitized, and the transmission speed of information is increased in proportion to an increase in size thereof. Accordingly, operating frequencies of communication devices and equipment are increasing higher and higher.

However, in high frequency circuits, the high dielectric constant of insulating material results in decreased transmission speed, noise with adjacent signals, and increased dielectric loss of signal. Thus, the development of insulating material for a multi-layer PCB having a lower dielectric constant has been thoroughly studied in order to support high frequencies of electronic systems.

The insulating layer of a material for a PCB, such as a CCL and a prepreg, is generally composed of polymer resin and a reinforcement in the form of a woven fabric having high mechanical strength and dimensional stability by weaving spun glass fibers.

Typically, a method of manufacturing a material for a PCB includes steps of incorporating glass fabric into an uncured polymer resin, partially curing the glass fabric to prepare a prepreg for use in interlayer adhesion of a multi-layer PCB, and then attaching copper foil to either or both surfaces of the prepreg through hot pressing, to manufacture single-sided or double-sided CCL.

The polymer resin recently used includes, for example, bismaleimide triazine resin, polyphenyleneoxide resin, polytetrafluoroethylene resin, liquid crystal polymer resin, etc., each of which has a lower dielectric constant than that of conventional epoxy resin such as FR-4, having a dielectric constant of 3.5 or higher, and thus may be applied to insulating material for a PCB and may be modified to decrease the dielectric constant so as to support high-frequency electronic circuits.

The glass fabric used for a material for a PCB such as a CCL and a prepreg functions to maintain mechanical properties such as bending strength and dimensional stability to heat and pressure to enable subsequent procedures to be conducted.

Such glass fabric is prepared by spinning about 60 glass filaments having a diameter of about 10 μm to prepare glass yarn, which is then woven. For example, E-glass, used for the preparation of glass fabric, is composed mainly of SiO₂ (about 54.3 wt%), and further includes additives, such as Al₂O₃, MgO, B₂O₃, CaO, Fe₂O₃, etc.

As for the glass fabric reinforcement, research into decreasing a dielectric constant and a dissipation factor through the development of the composition of the reinforcement, in addition to E-glass, is being conducted, led by the manufacturers of glass.

In this regard, a conventional method of decreasing the dielectric constant of glass fabric, serving as the reinforcement of a material for a PCB such as a CCL and a prepreg, is largely classified into two types, that is, a first method of decreasing the dielectric constant through the development of the composition of glass fiber for use in glass fabric, and a second method of decreasing the dielectric constant through the preparation of a fabric reinforcement using a composite material.

The first method of decreasing a dielectric constant through the development of the composition of glass fiber for the glass fabric is described below.

The composition and properties of glass developed to decrease the dielectric constant are summarized in Table 1 below. As is apparent from Table 1, E-glass, which is presently frequently used for glass fabric in a material for a PCB, has a high dielectric constant of 6.6 and is thus unsuitable for use as a reinforcement of insulating material for a high-frequency circuit. In addition, although D-glass and Q-glass have dielectric constants of 4.7 and 3.9, respectively, which are lower than that of E-glass, they have poor processability due to low meltability. Thus, the surface of glass fiber may be easily scratched, and pores may be present in the molten glass. As well, the glass fiber has low moisture resistance, therefore decreasing adhesion to the resin, resulting in unreliable PCBs.

TABLE 1
Composition and Properties of Commercially Available Glass Fiber

| | Composition | E-Glass | S-Glass | D-Glass | Q-Glass |
|---|---|---|---|---|---|
| Main | SiO₂ | 52-56 | 60-65.6 | 74.5 | 99.99 |
| Composition | CaO | 21-23 | 0-9 | 0.5 | — |
| | Al₂O₃ | 12-15 | 23-25 | 0.3 | — |
| | B₂O₃ | 4-6 | — | 22.0 | — |
| | MgO | 0.4-4 | 6-11 | — | — |
| | Na₂O | 0-1 | 0-0.1 | 1.0 | — |
| Properties | Softening Temp. (Tg) | 840 | 970 | 770 | 1670 |
| | Specific Gravity | 2.54 | 2.49 | 2.16 | 2.2 |
| | Dielectric Constant | 6.6 | 6.25 | 4.74 | 3.89 |
| | Dissipation Factor | 0.0011 | 0.0019 | 0.0009 | 0.0002 |
| | Coefficient of Thermal | 4.52E−6 | 2.39E−6 | 3.15E−6 | 0.54E−6 |
| | Expansion (mm/mm ° C.) | | | | |

In addition, among known literature regarding the other glass compositions for decreasing the dielectric constant, U.S. Pat. No. 4,582,748 discloses a glass fiber composition, including 50-66 wt% of SiO₂, 10-25 wt% of Al₂O₃, 5-15 wt% of B₂O₃, 15 wt% or less of MgO, 5 wt% or less of TiO₂, and 15 wt% or less of ZnO, having a coefficient of thermal expansion of 1-2.3 ppm/K, an elastic modulus of at least 10 Mpsi, and a dielectric constant of about 6 or less, with the weight ratio of Al₂O₃/MgO being 2-2.5.

Further, JP-A-6-219780 discloses a glass fiber composition including 50-60 wt% of SiO₂, 10-18 wt% of Al₂O₃, 11-25 wt% of B₂O₃, 6-14 wt% of MgO, 1-10 wt% of CaO, and 0-10 wt% of ZnO. According to the above patent, although at least 6 wt% of MgO and 10.5-15 wt% of MgO, CaO, and ZnO are added to increase productivity, MgO is easily phase-separated, thus undesirably increasing the dissipation factor.

Further, JP-A-7-10598 discloses a glass fiber composition including 50.0-65 wt% of SiO₂, 10.0-18 wt% of Al₂O₃, 1-25 wt% of B₂O₃, 0-10 wt% of CaO, 0-10 wt% of ZnO, 1-10 wt% of SrO and 1-10 wt% of BaO. However, the above patent, which represents an attempt to decrease the dielectric constant, is disadvantageous because BaO having a high dielectric constant must be used to decrease the viscosity of molten glass so as to increase processability, thus limitations are imposed on decreasing the dielectric constant of the composition. Also, the problem of corrosion of a melting furnace may occur.

Furthermore, U.S. Pat. No. 5,958,808 discloses a glass fiber composition including 50-60 wt% of SiO₂, 10-20 wt% of Al₂O₃, 20-30 wt% of B₂O₃, 0-5 wt% of CaO, 0-4 wt% of MgO, 0-0.5 wt% of Li₂O+Na₂O+K₂O, and 0.5-5 wt% of TiO₂, with a dielectric constant of 4.2-4.5.

In addition, U.S. Pat. No. 6,309,990-B2 and JP-A-10-102366 disclose techniques for preparing a glass composition having a low dielectric constant while maintaining workability.

In this way, the dielectric constant of the glass fiber composition according to the conventional techniques has been lowered to 4, through studies for decreasing the dielectric constant by varying the composition of E-glass, having a dielectric constant of 6.6. However, processability becomes poor due to the low meltability, thus causing pores and an irregular surface. As well, since the dielectric constant of SiO2, serving as a main component of glass, is about 3.9, glass fiber having a dielectric constant less than 3.9 is difficult to obtain merely by modifying the composition thereof.

On the other hand, as an example of the second method of decreasing the dielectric constant of the glass fabric using a fabric reinforcement made of composite material, U.S. Pat. No. 4,937,132 discloses a fabric woven from hybrid yarn prepared from glass fibers, heat resistant engineering plastic fibers and fluoroplastic fibers, for use in a reinforcement of a material for a PCB, in which the resultant fabric has a low dielectric constant while mechanical strength and heat resistance are maintained at a predetermined level.

However, the method of decreasing the dielectric constant of reinforcement using a composite material is also limiting and is thus difficult to use to support high frequencies of presently rapidly growing electronic systems.

As mentioned above, a material for a PCB, such as a CCL and a prepreg, is increasingly required to have a dielectric constant and a dissipation factor as low as possible in order to support high frequencies of rapidly developing electronic devices. Thus, with the goal of supporting high frequencies of electronic devices, various thorough attempts have been made in the field of PCBs to modify conventional epoxy resin, apply the resin having excellent high-frequency dielectric properties, and develop the glass composition of glass fabric used for a reinforcement of a material for PCBs. However, satisfactory technical development thereof has not yet been realized.

### SUMMARY OF THE INVENTION

Leading to the present invention, intensive and thorough research into fabric reinforcements of materials for PCBs, carried out by the present inventors aiming to avoid the problems encountered in the related art, resulted in the finding that a fabric prepared from a modified cyclic olefin copolymer may be used as a reinforcement of a material for a PCB, thereby simultaneously improving both the mechanical properties and the high-frequency properties of the material for a PCB.

Accordingly, an object of the present invention is to provide a fabric reinforcement using a modified cyclic olefin copolymer, which exhibits a lower dielectric constant and a lower dissipation factor than those of conventional glass fabric material, thus manifesting excellent high-frequency properties.

Another object of the present invention is to provide a resin substrate for a PCB, incorporated with the fabric reinforcement.

In order to accomplish the above objects, the present invention provides a fabric reinforcement using a modified cyclic olefin copolymer, which is prepared from filaments obtained by melting a modified cyclic olefin copolymer comprising a cyclic olefin copolymer backbone grafted with a monomer having at least one unsaturated carboxylic group, the modified cyclic olefin copolymer having a dielectric constant of 2-3 and a dissipation factor of 0.002-0.005.

In the fabric reinforcement, the filament preferably has an average diameter of 5-20 μm.

The modified cyclic olefin copolymer may be obtained by grafting the cyclic olefin copolymer backbone with the monomer having at least one unsaturated carboxylic group in the presence of a reaction initiator using a reactive extrusion process.

The cyclic olefin copolymer preferably has a melting point of 250-400° C.

The grafting monomer is selected from the group consisting of unsaturated carboxylic acid, ethylenically unsaturated carboxylic ester, ethylenically unsaturated carboxylic anhydride, and mixtures thereof.

The reaction initiator is selected from the group consisting of acyl peroxide, dialkyl or aralkyl peroxide, peroxyester, hydroperoxide, ketone peroxide, azo compounds, and mixtures thereof.

In addition, the present invention provides a resin substrate for a printed circuit board, including an insulating resin and the fabric reinforcement mentioned as above.

In the resin substrate, the insulating resin is preferably selected from the group consisting of epoxy resin, bismaleimide triazine resin, polyphenyleneoxide resin, polytetrafluoroethylene resin, liquid crystal polymer resin, and mixtures thereof.

### DETAILED DESCRIPTION OF THE INVENTION

Hereinafter, a detailed description will be given of the present invention.

The present invention pertains to a fabric reinforcement for use in a material for a PCB, such as a CCL and a prepreg, in which a cyclic olefin copolymer (COC) including polyolefin and cyclic olefin copolymerized together is used as a fabric material, thereby providing a fabric reinforcement having a dielectric constant decreased to 60% of a conventional value while maintaining mechanical strength and dimensional stability relative to conventional woven glass, and also providing a resin substrate for a PCB.

In the COC, polyolefin (all polymers composed of C and H, including polyethylene, polypropylene, etc.) to be copolymerized with cyclic olefin has excellent mechanical and electrical properties and thus has various applications. Particularly, polyolefin has a simple structure and good processability and is therefore suitable for use in the preparation of films, vessels or vinyl bags. Further, polyolefin may be widely applied even in the fields of polymer processing, including extrusion or injection molding.

Of such polyolefins, in the case of ultrahigh molecular weight polyethylene having a molecular weight of millions or more, a directional characteristic may be conferred to its polymer chain through excellent mechanical properties thereof, in particular, elongation, thereby manifesting high mechanical strength from tens of to hundreds of GPa. Thus, the above polyolefin may be used as a reinforcement of a material for a PCB such as a CCL and a prepreg to enhance the mechanical strength thereof.

However, since polyethylene or ultrahigh molecular weight polyolefin is electrically non-polar, it is incompatible not only with polar materials, such as nylon, polyester, aluminum, iron, paper and wood material, but also with polyolefin of the same kind, and has also poor adhesion, and thus, the use thereof has been limited.

Hence, in the present invention, a monomer having at least one unsaturated carboxylic group is grafted to the backbone of the COC, resulting in a modified COC, which is then used for a fabric material, thus increasing adhesion to the resin.

The modified COC is prepared by-modifying the COC to have a hydrophilic group in the presence of a reaction initiator through a reactive extrusion process in order to realize inexpensive polymer synthesis.

Upon the preparation of the modified COC, the COC used as the reaction material preferably has a melting point (Tm) of 250-400° C., and includes, for example, but is not limited to, compounds containing norbornene or ethylene as a polymerization unit. If the Tm of the COC is lower than 250° C., the fabric reinforcement is melted upon the lamination of the substrate and is greatly deformed. On the other hand, if the Tm is higher than 400° C., the temperature required for the preparation of the fiber is increased, thus decreasing the processability.

The grafting monomer used for the modification is selected from the group consisting of unsaturated carboxylic acid, ethylenically unsaturated carboxylic ester, ethylenically unsaturated carboxylic anhydride, and mixtures thereof.

Preferably, the grafting monomer is selected from the group consisting of unsaturated carboxylic acid, for example, acrylic acid, methacrylic acid, ethacrynic acid, maleic acid, fumaric acid, etc.; ethylenically unsaturated carboxylic ester, for example, glycidylmethacrylate, methylmethacrylate, 2-hydroxyethylacrylate, 2-hydroxyethylmethacrylate, monoethylmaleate, diethylmaleate, di-n-butylmaleate, etc.; and ethylenically unsaturated carboxylic anhydride, for example, maleic anhydride, 5-norbornene-2,3-anhydride, nadic anhydride, etc.

More preferably, the grafting monomer is methylmethacrylate or maleic anhydride.

Further, the reaction initiator for use in grafting the COC with the grafting monomer through the reactive melt process is selected from the group consisting of acyl peroxide, dialkyl or aralkyl peroxide, peroxyester, hydroperoxide, ketone peroxide, azo compounds, and mixtures thereof.

Preferably, the reaction initiator is selected from the group consisting of acyl peroxide, for example, benzoyl peroxide; dialkyl or aralkyl peroxide, for example, di-t-butyl peroxide, dicumyl peroxide, cumyl butyl peroxide, 1,1-di-t-butylperoxy-3,5,5-trimethylcyclohexane, 2,5-dimethyl-2,5-di-t-butylperoxyhexane, bis(t-butylperoxyisopropyl)benzene, etc.; peroxyester, for example, t-butylperoxypivalate, t-butyl di(perphthalate), dialkylperoxymonocarbonate, peroxydicarbonate, t-butylperbenzoate, 2,5-dimethylhexyl-2,5-di(perbenzoate), t-butylperoctoate, etc.; hydroperoxide, for example, t-butyl hydroperoxide, p-methane hydroperoxide, pinane hydroperoxide, cumen hydroperoxide, etc.; ketone peroxide, for example, cyclohexanone peroxide, methylethylketone peroxide, etc.; and azo compounds, for example, azobis isobutyronitrile.

More preferably, the reaction initiator is dicumyl peroxide.

The modified COC is imparted with excellent adhesion by grafting the ethylene portion of the backbone of the COC with the monomer having at least one unsaturated carboxylic group such as —COOH or —COOCH₃ as a hydrophilic functional group.

The modified COC has superior electrical properties, including a dielectric constant as low as 3 or less and a dissipation factor of about 0.005 or less, and as well, optical transparence.

In consideration of the inherent limitation of usable material and economical efficiency of the actual preparation process, it is preferred that the modified COC have a dielectric constant of 2-3 and a dissipation factor of 0.002-0.005. If the dielectric constant of the modified COC falls outside of the above range, the dielectric constant of insulating material for a substrate is decreased, and signal interference occurring upon transmission of a high-frequency signal may not be sufficiently reduced. In addition, when the dissipation factor falls outside of the above range, signal loss is not undesirably decreased.

As well, the molecular weight and structure of the modified COC and the polymerization ratio of polyolefin and cyclic olefin thereof may be appropriately controlled depending on end purposes, whereby a glass transition temperature can be increased to 400° C. or higher, thus assuring heat resistance, which is essential for use in reinforcing the material for a PCB.

The modified COC having the above properties is prepared into a filament through a melt process. A plurality of filaments is spun into yarn, which is then woven to obtain the fabric reinforcement of the present invention.

The filament prepared from the modified COC preferably has an average diameter of 5-20 μm from a process point of view of being spun into yarn, which is then woven.

According to the present invention, in the case where the fabric reinforcement of a material for a high-frequency PCB using the modified COC is incorporated into a general insulating resin for a PCB to manufacture a substrate, the substrate thus manufactured can have a dielectric constant and a dissipation factor lower than those of substrates manufactured using conventional reinforcements, thus exhibiting excellent dielectric properties.

In addition, the reinforcement of the present invention can be developed into a CCL and prepreg having a dielectric constant of about 2.5 or less, when used along with a resin having a lower dielectric constant, such as liquid crystal polymer.

The insulating resin is not particularly limited, but is selected from the group consisting of epoxy resin, bismaleimide triazine resin, polyphenyleneoxide resin, polytetrafluoroethylene resin, liquid crystal polymer resin, and mixtures thereof.

A better understanding of the present invention may be obtained in light of the following examples which are set forth to illustrate, but are not to be construed to limit the present invention.

### EXAMPLE 1

100 parts by weight of COC having a Tm of 300° C., 20 parts by weight of methylmethacrylate, and 10 parts by weight of dicumyl peroxide were stirred at about 25° C., and then loaded into a twin screw extruder. The mixture was extruded at about 300° C. for about 15 min, dissolved in hot xylene, and then precipitated in cold acetone to remove impurities. The resulting precipitate was dried at about 60° C. to obtain a COC grafted with a monomer (hereinafter, referred to as “GRA-COC”). The GRA-COC thus prepared had a dielectric constant of 2.8 and a dissipation factor of 0.003.

Then, the GRA-COC was melted to prepare a filament having a diameter of about 10 μm. A plurality of filaments was spun into yarn, which was then woven, thus yielding a fabric having a thickness of about 170 μm.

### EXAMPLE 2

100 parts by weight of COC having a Tm of 300° C., 20 parts by weight of maleic anhydride, and 10 parts by weight of dicumyl peroxide were stirred at about 25° C., and then loaded into a twin screw extruder. The mixture was extruded at about 300° C. for about 15 min, dissolved in hot xylene, and then precipitated in cold acetone to remove impurities. The resulting precipitate was dried at about 60° C. to obtain a GRA-COC. The GRA-COC thus prepared had a dielectric constant of 2.7 and a dissipation factor of 0.003.

Thereafter, the GRA-COC was melted to prepare a filament having a diameter of about 10 μm. A plurality of filaments was spun into yarn, which was then woven, thus yielding a fabric having a thickness of about 170 μm.

### EXAMPLE 3

100 parts by weight of COC having a Tm of 300° C., 20 parts by weight of methylmethacrylate, and 10 parts by weight of benzoyl peroxide were stirred at about 25° C., and then loaded into a twin screw extruder. The mixture was extruded at about 300° C. for about 15 min, dissolved in hot xylene, and then precipitated in cold acetone to remove impurities. The resulting precipitate was dried at about 60° C. to obtain a GRA-COC. The GRA-COC thus prepared had a dielectric constant of 2.6 and a dissipation factor of 0.003.

Thereafter, the GRA-COC was melted to prepare a filament having a diameter of about 10 μm. A plurality of filaments was spun into yarn, which was then woven, thus yielding a fabric having a thickness of about 170 μm.

### EXAMPLE 4

100 parts by weight of COC having a Tm of 300° C., 20 parts by weight of methacrylic acid, and 10 parts by weight of benzoyl peroxide were stirred at about 25° C., and then loaded into a twin screw extruder. The mixture was extruded at about 300° C. for about 15 min, dissolved in hot xylene, and then precipitated in cold acetone to remove impurities. The resulting precipitate was dried at about 60° C. to obtain a GRA-COC. The GRA-COC thus prepared had a dielectric constant of 2.9 and a dissipation factor of 0.004.

Thereafter, the GRA-COC was melted to prepare a filament having a diameter of about 10 μm. A plurality of filaments was spun into yarn, which was then woven, thus yielding a fabric having a thickness of about 170 μm.

In order to compare the bending strength and dielectric properties of epoxy CCLs manufactured using the fabric prepared in Examples 1-4 as a reinforcement and of an epoxy CCL made using a conventional glass fabric reinforcement, CCL samples were prepared as follows (Examples 5-8 and Comparative 1).

### EXAMPLE 5

0.01 wt% of iron (III) acetylacetonate was added to 95 wt% of 2,2-bis(4-cyanatophenyl)propane prepolymer and 5 wt% of bisphenyl A epoxy resin. The mixture was dissolved in methylethylketone (MEK) to prepare epoxy varnish.

Thereafter, the fabric obtained in Example 1 was incorporated into the above epoxy varnish and then dried at about 140° C. for 7 min to prepare a prepreg.

Subsequently, copper foil having a thickness of about 18 μm was laid-up on both surfaces of the prepreg, after which lamination was conducted at about 175° C. under pressure of about 40 kg/cm² for 2 hours using a hot vacuum press, to manufacture a double-sided CCL.

The electrical and mechanical properties of the CCL sample thus manufactured were measured. The results are shown in Table 2 below.

### EXAMPLE 6

0.01 wt% of iron (III) acetylacetonate was added to 95 wt% of 2,2-bis(4-cyanatophenyl)propane prepolymer and 5 wt% of bisphenyl A epoxy resin. The mixture was dissolved in MEK to prepare epoxy varnish.

Thereafter, the fabric obtained in Example 2 was incorporated into the above epoxy varnish and then dried at about 140° C. for 7 min to prepare a prepreg.

Subsequently, copper foil having a thickness of about 18 μm was laid-up on both surfaces of the prepreg, after which lamination was conducted at about 175° C. under pressure of about 40 kg/cm² for 2 hours using a hot vacuum press, to manufacture a double-sided CCL.

The electrical and mechanical properties of the CCL sample thus manufactured were measured. The results are shown in Table 2 below.

### EXAMPLE 7

0.01 wt% of iron (III) acetylacetonate was added to 95 wt% of 2,2-bis(4-cyanatophenyl)propane prepolymer and 5 wt% of bisphenyl A epoxy resin. The mixture was dissolved in MEK to prepare epoxy varnish.

Thereafter, the fabric obtained in Example 3 was incorporated into the above epoxy varnish and then dried at about 140° C. for 7 min to prepare a prepreg.

Subsequently, copper foil having a thickness of about 18 μm was laid-up on both surfaces of the prepreg, after which lamination was conducted at about 175° C. under pressure of about 40 kg/cm² for 2 hours using a hot vacuum press, to manufacture a double-sided CCL.

The electrical and mechanical properties of the CCL sample thus manufactured were measured. The results are shown in Table 2 below.

### EXAMPLE 8

0.01 wt% of iron (III) acetylacetonate was added to 95 wt% of 2,2-bis(4-cyanatophenyl)propane prepolymer and 5 wt% of bisphenyl A epoxy resin. The mixture was dissolved in MEK to prepare epoxy varnish.

Thereafter, the fabric obtained in Example 4 was incorporated into the above epoxy varnish and then dried at about 140° C. for 7 min to prepare a prepreg.

Subsequently, copper foil having a thickness of about 18 μm was laid-up on both surfaces of the prepreg, after which lamination was conducted at about 175° C. under pressure of about 40 kg/cm² for 2 hours using a hot vacuum press, to manufacture a double-sided CCL.

The electrical and mechanical properties of the CCL sample thus manufactured were measured. The results are shown in Table 2 below.

### COMPARATIVE EXAMPLE 1

0.01 wt% of iron (III) acetylacetonate was added to 95 wt% of 2,2-bis(4-cyanatophenyl)propane prepolymer and 5 wt% of bisphenyl A epoxy resin. The mixture was dissolved in MEK to prepare epoxy varnish.

Thereafter, glass fabric about 170 μm thick (E-glass/Nittobo G/F, 7628) was incorporated into the epoxy varnish and then dried at about 140° C. for 7 min to prepare a prepreg.

Subsequently, copper foil having a thickness of about 18 μm was laid-up on both surfaces of the prepreg, after which lamination was conducted at about 175° C. under pressure of about 40 kg/cm² for 2 hours using a hot vacuum press, to manufacture a double-sided CCL.

The electrical and mechanical properties of the CCL sample thus manufactured were measured. The results are shown in Table 2 below.

TABLE 2
Properties of Double-Sided CCLs Depending on the Kind of Fabric

| | Ex. 5 | Ex. 6 | Ex. 7 | Ex. 8 | C. Ex. 1 | Note |
|---|---|---|---|---|---|---|
| Thickness of Insulating Layer | 190 | 193 | 190 | 191 | 193 | |
| (mm) | | | | | | |
| Thickness of Copper Foil | 18 | 18 | 18 | 18 | 18 | |
| (μm) | | | | | | |
| Dielectric Constant (@ 1 MHz) | 3.4 | 3.4 | 3.1 | 3.6 | 4.4 | |
| Dissipation Factor | 0.011 | 0.011 | 0.009 | 0.013 | 0.015 | |
| (@ 1 MHz) | | | | | | |
| Bending Strength (kg/mm²) | 21 | 22 | 21 | 23 | 23 | |
| Adhesion Strength (kg/cm) | 1.51 | 1.52 | 1.49 | 1.55 | 1.58 | |
| Heat Resistance | No | No | No | No | No | J-STD- |
| | Change | Change | Change | Change | Change | 020C |

As is apparent from Table 2, the double-sided CCLs (Examples 5-8) manufactured using the fabric prepared from GRA-COC as a reinforcement could be confirmed to exhibit excellent electrical properties having a dielectric constant of 3.1-3.6 and a dissipation factor of 0.009-0.013, without drastic reduction of mechanical properties, compared to those of the double-sided CCL (Comparative Example 1) manufactured using a conventional fabric reinforcement.

The preferred embodiments of the present invention, regarding the fabric reinforcement using a modified COC and the resin substrate for a PCB, have been disclosed for illustrative purposes, but are not to be construed to limit the present invention, and those skilled in the art will appreciate that various modifications, additions and substitutions are possible, without departing from the spirit of the invention.

As described hereinbefore, the present invention provides a fabric reinforcement using a modified COC and a resin substrate for a PCB. According to the present invention, the fabric reinforcement is prepared from filaments obtained by melting the COC grafted with an unsaturated carboxylic group, and thus, can exhibit mechanical properties equal or superior to conventional glass fabric materials. In addition, the fabric reinforcement of the present invention has a lower dielectric constant and a lower dissipation factor than those of conventional glass fabric materials, thus manifesting excellent high-frequency properties.

Many modifications and variations of the present invention are possible in light of the above teachings, without departing from the scope and spirit of the invention as disclosed in the accompanying claims.

What is claimed is:

1. A fabric reinforcement, comprising: a modified cyclic olefin copolymer, prepared from filaments obtained by melting, wherein the modified cyclic olefin copolymer comprises:
a cyclic olefin copolymer backbone grafted with a monomer having at least one unsaturated carboxylic group, the modified cyclic olefin copolymer having a dielectric constant of 2-3 and a dissipation factor of 0.002-0.005.

2. The fabric reinforcement as set forth in claim 1, wherein the filament has an average diameter of 5-20 μm.

3. The fabric reinforcement as set forth in claim 1, wherein the modified cyclic olefin copolymer is obtained by grafting the cyclic olefin copolymer backbone with the monomer having at least one unsaturated carboxylic group in the presence of a reaction initiator using a reactive extrusion process.

4. The fabric reinforcement as set forth in claim 1, wherein the cyclic olefin copolymer has a melting point of 250-400° C.

5. The fabric reinforcement as set forth in claim 1, wherein the monomer is unsaturated carboxylic acid, ethylenically unsaturated carboxylic ester, ethylenically unsaturated carboxylic anhydride, or mixtures thereof.

6. The fabric reinforcement as set forth in claim 1, wherein the monomer is acrylic acid, methacrylic acid, ethacrynic acid, maleic acid, fumaric acid, glycidylmethacrylate, methylmethacrylate, 2-hydroxyethylacrylate, 2-hydroxyethylmethacrylate, monoethylmaleate, diethylmaleate, di-n-butylmaleate, maleic anhydride, 5-norbornene-2,3-anhydride, nadic anhydride, or mixtures thereof.

7. The fabric reinforcement as set forth in claim 3, wherein the reaction initiator is acyl peroxide, dialkyl or aralkyl peroxide, peroxyester, hydroperoxide, ketone peroxide, azo compounds, or mixtures thereof.

8. The fabric reinforcement as set forth in claim 3, wherein the reaction initiator is benzoyl peroxide, di-t-butyl peroxide, dicumyl peroxide, cumyl butyl peroxide, 1,1-di-t-butylperoxy-3,5,5-trimethylcyclohexane, 2,5-dimethyl-2,5-di-t-butylperoxyhexane, bis(t-butylperoxyisopropyl)benzene, t-butylperoxypivalate, t-butyl di(perphthalate), dialkylperoxymonocarbonate, peroxy dicarbonate, t-butyl perbenzoate, 2,5-dimethylhexyl-2,5-di(perbenzoate), t-butyl peroctoate, t-butyl hydroperoxide, p-methane hydroperoxide, pinane hydroperoxide, cumen hydroperoxide, cyclohexanone peroxide, methylethylketone peroxide, azobis isobutyronitrile, or mixtures thereof.

9. A resin substrate for a printed circuit board, comprising an insulating resin and the fabric reinforcement of claim 1.

10. The resin substrate as set forth in claim 9, wherein the insulating resin is epoxy resin, bismaleimide triazine resin, polyphenyleneoxide resin, polytetrafluoroethylene resin, liquid crystal polymer resin, or mixtures thereof.
